(19) United States
(12) Patent Application Publication
(10) Pub. No.: US 2018/0244575 A1
(43) Pub. Date: Aug. 30, 2018

(54) Method For Producing A Cementitious Composite, And Long-Life Micro/Nanostructured Concrete And Mortars Comprising Said Composite

(71) Applicants: Consejo Superior de Investigaciones Cientificas, Madrid (ES); Universidad Politécnica de Madrid, Madrid (ES); Universidad Complutense de Madrid, Madrid (ES)

(72) Inventors: José Francisco FERNÁNDEZ LOZANO, Madrid (ES); Maria Pilar Leret Molto, Madrid (ES); Amparo Moragues Terrades, Madrid (ES); Encarnación Reyes Pozo, Madrid (ES); Jaime Carlos Gálvez Ruiz, Madrid (ES); Elvira Sánchez Espinosa, Madrid (ES); Daniel Alonso Dominguez, Madrid (ES); Inmaculada Álvarez Serrano, Madrid (ES)

(21) Appl. No.: 15/934,084

(22) Filed: Mar. 23, 2018

Related U.S. Application Data
(63) Continuation of application No. PCT/ES2016/070666, filed on Sep. 22, 2016.

(30) Foreign Application Priority Data
Sep. 25, 2015 (ES) P201531373

(51) Int. Cl. C04B 28/04; C04B 40/00

(52) U.S. Cl. CPC C04B 28/04; C04B 40/0028; C04B 2111/00008; C04B 2235/3208; C04B 2235/3418

(57) ABSTRACT

The invention relates to a method for producing a cementitious composite, comprising: 1) a first step of conditioning silica nanoparticles, in which the nanoparticles are heated to a temperature between 85-235° C. for a sufficiently long time interval so as to obtain a maximum humidity content of 0.3% relative to the total weight of the material resulting from the first step; 2) a dry dispersion step, in which the conditioned nanoparticles in step 1) are dispersed over cement and in which inert grinding balls are used; 3) a step of conditioning the cementitious composite obtained in step 2), in which the grinding balls are separated from the cementitious composite produced. The invention also relates to the resulting composite, to cement derivatives comprising said composite, preferably mortars and concrete, to the production method thereof and to the use of these materials in industry.

### CROSS-REFERENCE TO RELATED APPLICATIONS

This application is a continuation of and claims priority to PCT Application No. PCT/ES2016/070666, filed Sep. 22, 2016 and titled Method for Producing a Cementitious Composite, and Long-Life Micro/Nanostructured Concrete and Mortars Comprising Said Composite, which, in turn, claims priority to Spanish Application No. P201531373, filed Sep. 25, 2015, the entire contents of each application is incorporated herein by reference.

### FIELD OF THE INVENTION

The present invention relates to the technology of cementitious composite and cement-based materials, such as mortars and concrete, and their methods of preparation and use in industry, especially in the construction sector.

### STATE OF THE ART

Cements are the basis of the materials used in construction such as mortars and concrete.

Cement is the most commonly used binder material in civil construction; said material is mainly composed of silicate phases, aluminate phases, gypsum and, to a lesser extent, ferrite. When hydrated, these components result in some crystalline phases and other amorphous phases, known as calcium silicate hydrates (C—S—H gels). C—S—H gels represent more than half of the total hydrated products and are mainly responsible for the mechanical properties of cement-based materials. These gels are made up of finite chains of tetrahedra [SiO₄] that share vertices, which are repeated following the pattern (3n−1), where n is an integer that accounts for the possible absence of tetrahedrons arranged in the bridge position in the structure.

The inclusion of additional materials to improve the characteristics of these materials obtained from cement is a field of great interest since in this way their critical characteristics are improved and their applications are expanded and improved.

The inclusion of nanoparticles in cement-based construction materials such as mortars and concrete has shown to be an interesting method due to its improvement of resistant capacities and/or the contribution of functional properties. In this way, the different kinds of existing nanoparticles are included to increase the mechanical properties or to achieve new benefits such as: hydrophobicity, photocatalysis, electromagnetic shielding, bactericidal or fungicidal character, etc.

In this sense, it is described that the addition of graphene nanoparticles as nanoplatelets produces a restriction on the penetration of CO₂ (WO2015084438 A1). The main limitation in the preparation of the materials is the high requirement of organic additives for their processing since they present workability problems. (WO2015084438 A1 and KR20150036928 A). A strong limitation in the use of nanomaterials for cement-based materials is that it implies greater complexity in its execution, requiring specialized personnel and individual protection equipments that are unusual in the construction sector.

The inclusion of nanoparticles of aluminum, alumina, titanium dioxide, indium tin oxide, tin oxide doped with particular aluminum, or zinc oxide with a size below the visible, less than 150 nm, in the mortar layer coating in a concrete provides reflective properties in the infrared range (DE102012105226 A1). The limitations of the method are related to the inclusion of polyurethane in the coating and the subsequent spraying of nanoparticles by means of projection or infiltration that make a complex method and high cost in the commissioning. Other methods of nanoparticles inclusion consist of the use of aqueous suspensions with silane coupling agents to obtain hydrophobic effects once they are applied to mortars or concrete (CN 103275616 A). The use of hardening methods by autoclave or semi-autoclave treatments that improves the resistance to acids if nanoparticles of silica aerosols are used, in water-oil emulsions with sodium carbonate in mortars that cover metal parts is described in UA56379 U.

On the other hand, the durability of coatings including nanoparticles applied on mortars or concrete is not considered since it is limited by the nanoparticles' own surface location.

The addition of 1-3% by weight of nanosilicate to a PORTLAND SAUDI TYPE-G cement allows its use in oil wells at high temperatures (290° F. which equals 143° C.) and high pressure (ca. 55-62 MPas) (US2014332217 A1). The method of preparation requires the use of high shear up to 12000 rpm to disperse the nanosilicate particles. In a method of inclusion of up to 20% of inorganic nanotubes based on silicoaluminates, previous aqueous dispersions are required for their inclusion into cementitious compositions (AU2013323327 A1). Other methods involve the use of dispersants in aqueous solutions to pre-disperse the nanoparticles (CN103664028 A) (RU2474544 C1).

However, the improvement in properties is partly limited by the difficulty in methods of nanoparticles dispersion. The addition of boehmite nanoparticles between 2 nm and 80 nm together with silicon oxide, calcium oxide and magnesium oxide in a percentage of up to 25% to increase the resistance to compression of mortars to <73 MPas with only 0.75% by weight of alumina nanoparticles is described in US2014224156 A1.

Application WO2010010220 refers to a dry dispersion of nanoparticles on microparticles, however, does not suggest the need for a pre-conditioning step before dispersion, as in the examples described in WO2010010220 preconditioning is not performed.

An improvement of the structural properties up to values of cements type 72.5-82.5 requires mechano-chemical activation methods of Portland cement by means of milling until reaching specific surface values of 300-900 m²/kg and the inclusion of polymeric additives (WO2014148944 A1). These methods require high energy consumption and cause an increase in the volume of the material that is also difficult to store and handle due to its high reactivity. The inclusion of glycerin assists the nucleation of crystals based on calcium silicate with a reduction of its size for an improvement of its mechanical resistance and allows the use of high pressures for its compaction in applications of oil wells (EP2695850 A1). However, a limitation of the state of the art is that the presence of a greater volume of crystals weaken the material, in particular when the hydration transformations take place, as occurs with the ettringite phases that evolve during setting to calcium monosulfoaluminate and whose subsequent hydration causes accelerated degradation of the material.

The waterproofing of mortars is achieved with silica nanoparticles up to 10% by weight and between 5-2% by weight of additives using mixing methods with speeds of 1440 rpm and times of 45 minutes (CN102718446 A). The nanoparticles allow the decrease in permeability by assuming that they are located in the interstices of the cement and sand and gravel particles (CN 102378743 A) and preferably assist the formation of the ettringite phase during setting (DE102012105226 A1). The appearance of ettringite may be limiting for the durability of mortars if their transformation to phases with volume change occurs. However, the limitations of these methods are claimed for particles between 0.1 to 1 mm. In the state of the art, the location of the nanoparticles in cementitious mixtures is not unequivocally demonstrated and to a lesser degree in the final composites due to the complexity of the mortars and concrete. In the state of the art, the methods of inclusion of nanoparticles in cementitious compositions are not standardized and are insufficient to achieve the properties of mechanical resistance and waterproofing required for products of long durability, in particular for larger sand and gravel such as in the case of concrete.

In recent decades, many researchers have used different types of additions in Portland cement looking for them to modify the porosity, morphology, composition and nanostructure of the C—S—H gels, in order to improve the durability and resistant properties of the departure cement.

In the last two decades, cement-based materials with nano- and microsilica additions have been prepared and studied, obtaining great improvements in relation to ordinary Portland cement. These improvements have been related to aspects concerning the composition and structural aspects of the C—S—H gels, and Silicon 29 Nuclear Magnetic Resonance, ²⁹Si-MAS-NMR, and Scanning Electron Microscopy, SEM are of great interest for their study. Gaitero et al. studied cement pastes with additions of nanosilica and verified, by means of ²⁹Si-MAS-NMR, that these led to greater hydration grades and higher silica gel chain lengths C—S—H than the ordinary Portland cement paste that they used as reference (Gaitero, J J, Campillo, I., Guerrero, A., “Reduction of the calcium leaching rate of cement paste addition of silica nanoparticles” Cem. Concr. Res, 2008: 38, pp. 11 12-1 118). Two years later, Mondal et al. also verified this fact when samples with additions of micro- and nanosilica were compared. They also observed that samples with nanosilica substantially improved the durable properties of ordinary Portland cement (Mondal, P., Shah, S P, Marks, L D, Gaitero, J J, “Comparative study of the effects of microsilica and nanosilica in concrete” Journal of the Transportation Research Board, 2010: 2141, pp. 6-9).

It was observed how the addition of nano- and microsilica causes an increase in the density and compactness of the C—S—H gels, in addition to modifying their morphology. Decreases in the amount, size and crystallinity of the portlandite, and refinement of the porous structure were also observed. When the addition used is microsilica, percentages close to 10% are necessary for remarkable improvements in the mechanical behavior of the materials in relation to the references used, on the order of a 30% increase in the resistance to compression values (the obtained values will depend on the dosages used) (Nazari, A., Riahi, S., “The effects of SiO₂ nanoparticles on physical and mechanical properties of high strength compacting concrete” Comp. B, 2011: 42, pp. 570-578). However, the inclusion of nanosilica allows the values of said parameter to be increased up to 60%, lower addition percentages being sufficient.

The addition to concrete, with sand and gravel/cement ratio of 0.3, of up to 10% by weight of microsilica significantly modifies the porous structure (28% decrease in total porosity), in relation to the reference sample at relatively low curing agess, the Improvements being less important for 90 days of curing (Poon, C S, Kou, S C, Lam, L, “Compressive strength, chloride diffusivity and pore structure of high performance metakaolin and silica fume concrete” Cons. Build. Mater, 2006: 20, pp. 858-865). In order to increase the pozzolanic activity and to improve the porous structure and the durability, nanosilica additions are currently being used, showing that its use leads to greater improvements than the microsilica. For example, the inclusion of 5% of nanosilica allows to increase the electrical resistivity in 30% and the resistance to the penetration of chlorides, after 7 days of curing in 50% (Madani, H., Bagheri, A., Parhizkar, T., Raisghasemi, A., “Chloride penetration and electrical resistivity of concretes containing nanosilica hydrosols with different specific surface areas” Cem. Concr. Comp, 2014: 53, pp. le24). Moreover, it has been described that the provision of 5% of nanosilica in mortars results in a 70% increase in resistivity and 80% decrease in the chloride migration coefficient (Zahedi, M., Ramezanianpour, A A., Ramezanianpour, A M, “Evaluation of the mechanical properties and durability cement mortars contanining nanosilica and rise husk ash under chloride ion penetration” Cons. Build. Mater, 2015: 78, pp. 354-361).

The effectiveness of the use of silica nanoparticles in the improvement of the properties of concrete and mortars depends on many factors such as: the proportions used, if they are added additionally or in substitution of any of the components, the step of inclusion, the type of mixing, the previous method of preparation, the state of agglomeration, the size and structure, etc.

As an example of the difficulties in the standardization of the methods of preparation of cementitious materials that include nanoparticles, it is common a lack of clarity when it is sometimes described that an “in dry state” dispersion is carried out, but without reference to a thermal preconditioning. In the state of the art it is usual to refer to the dry state, calculated as the weight of the material in the absence of humidity, to formulate the dosing of the materials, but for practical reasons the materials in large volumes are not subjected to previous drying methods by economic cost since water is added as a necessary step in obtaining mortars and/or concrete from cement. The inorganic solids “in dry state” have a proportion of absorbed water that depends on the relative humidity of the air, temperature, atmospheric pressure, nature of the surface of the solid and specific surface. It is expected that in a scientific work on this technology explicitly explain if there is complete absence of humidity as it implies an added complication in the handling of powdery material. Completely dry materials are more volatile when increasing their electrostatic charge and also present explosion risks. In the case of nanoparticles these effects are magnified.

In addition to the properties of the obtained materials, the cost is another of the critical factors in the field of construction. The more preparation steps these mortars and concrete have, the more expensive manufacturing them will be, and thus the complexity in the production of materials as well as the cost thereof will be increased. In general, all the improvements are focused on achieving a percentage improvement of the properties that in no case would allow more than double the useful life of the cementice material. In order to achieve improvement effects, highly complex and highly expensive additive compositions are required. Therefore, materials that significantly increase the useful life of the materials in an effective manner and simple and economical methodologies are required.

Furthermore, a particular case of the limitations of the state of the art for the increase of the durability is the formation of expansive products from the hydrated phases. Specifically, the evolution of the first ettringite formed (primary ettringite) to calcium monosulfoaluminate leaves the possibility of reaction open with external sulphates and subsequent formation of ettringite phase (secondary ettringite), generating very significant increases in volume in hardened state, that cause significant internal stresses and cracking. This effect causes a significant deterioration of the mechanical and durable properties of cementitious materials, reducing significantly their service life. In the state of the art one tries to control this process by means of the use of cements with low content of aluminates and/or the use of additions such as slag or fly ash. The limitation of aluminates in cements complicates the manufacturing method of them and limits some of the characteristics of the material. In the case of additions, their use is currently limited by the reduction in availability.

Therefore it is necessary to obtain cementitious composites for the improvement of the characteristics of mortars and concrete, wherein:
an effective inclusion of nanoparticles and/or microparticles be carried out into mortar and concrete preparation methods. Specifically in nanoparticles, its nanometric dimension causes the diffuse emission of nanoparticles that, on the one hand prevents its control, and on the other hand, generates environmental problems. Its small size implies high volatility since it causes the presence of nanoparticle clouds that are difficult to control. In addition, the high specific surface area of the nanoparticles causes a state of agglomeration thereof which until now is only partially solved by dispersion in liquid suspensions, for example aqueous. The use of nanoparticles generally involves the use of chemical additives of the polymeric type that improve the rheology to ensure the necessary workability in this type of material;
the number of unit operations and components be simplified to optimize costs. The high price of nanoparticles, their low effectiveness due to agglomeration and the complexity of handling imply a high number of unit operations required for their use. Complexity in use implies methods that increase the final cost and therefore restricts its use for very specific applications;
handling risks of nanomaterials be reduced. The high reactivity of nanoparticles represents a potential danger for their use, given the proven absence of nano-toxicology studies, which imply restrictions in its handling, such as the use of individual protection equipment that is not common in the construction sectors mortars and concrete are destined;
the durability of the resulting materials be improved. It has not been demonstrated that simple methods of using nanoparticles can be used for the generation of cementitious materials, particularly for using in applications that require periods of useful life exceeding 100 years. In this case, a long durability of the materials is necessary, which results in greater sustainability of the construction methods. The main limitation of durability is the connectivity and size of the porous network, through which the external aggressive agents, that affect the cementitious matrix and the steel embedded in the structural concrete, access. Historically, additions have been used to refine the porous structure. However, at the moment, the necessary increase of useful life of the structures demanded by technical requirements in search of greatersustainability, makes necessary cementitious materials with significant improvements in this aspect.

### Definitions

For more clarity some definitions are introduced:
“cement” refers to a mixture of calcium silicates and aluminates, obtained by cooking calcareous, clay and sand. The material obtained, very finely ground, once mixed with water, hydrates and solidifies progressively, acquiring resistance, even under water. Cements can be of clay origin and be obtained from clay and limestone; or of pozzolanic origin. These are industrial products that have different nomenclatures in accordance with national use standards;
“cement particles” or “cement microparticles” refers to cement in powder form with sizes between 1 μm and 500 μm;
“cementitious composite or cementitious” is defined as a mixture of materials that contain cement particles and that react hydraulically in the presence of water;
“silica nanoparticles” are defined when at least 50% of the silica particles size is below 100 nm;
“microsilica” and “silica microparticles” are used interchangeably, and refers to a silica material in an agglomerated state comprising silica nanoparticles and which in its transport and handling behaves as a micrometric material due to its state of agglomeration.

In the present Invention the expression “silica particles” will be used to refer to silica particles with at least 50% of particles with a size below 100 nm which are forming strongly cohesive agglomerates defined as silica microparticles, or microsillca, or else they are forming cohesive agglomerates defined as a nanosilica, or fumed silica—silica fume—. In other words, whether we talk about:
silica particles of dimensions of the order of nanometers, dispersed—which would be nanoparticles themselves—or we talk about
silica microparticles—which would be agglomerated nanoparticles and therefore in the form of particles that can be of micrometric dimensions—or
the mixture of the above
   indistinctly we will refer to them as “silica nanoparticles”;
“superplasticizer” and “superfiuidizer” are used interchangeably, and refer to a polycarboxylic ether also referred to as polycarboxylate or last generation superplasticizer. They are used as water reducing additives that produce a dispersing effect between the cement particles during the mixing in water combining the electrostatic and steric effects;
“dispersion” refers to the spreading of one substance within another that is much more abundant than the first one. The term dispersion in chemistry refers to a colloidal dispersion is a physicochemical system consisting of two or more phases: a continuous one, normally fluid, and another one dispersed in the form of, generally, solid particles, between 5 and 200 nm. In the state of the art the term dispersion does not establish a parameter to determine the degree of dispersion, as it happens in mathematics, where it refers to the degree of distance of a set of values with respect to its average value. In the state of the art the term dry dispersion refers to a dispersion of solid particles, between 5 and 200 nm, in other solid particles, greater than 100 nm. If the nanoparticles represent the dispersed phase, the state of the art likewise uses the term “nanodispersion”;
“dry” or “in dry state” material refers to a material that does not contain added water. The water content in a solid material is determined as the amount of water contained in the solid referred to the wet solid (dry solid plus water). Material “without absorbed water” refers to a dry material that is not in equilibrium with the partial pressure of the water vapor contained in the air and that has the water vapor absorption capacity maximized. When a substance is exposed to air (not saturated) it will begin to evaporate or condense water in it until the partial pressures of the water vapor contained in the air and the liquid contained in the solid are equalized. For a given temperature, the equilibrium humidity of the solid will depend, therefore, on the relative humidity of the air;
“durability” of concrete refers to the ability of concrete to resist the action of weathering, chemical attack, and abrasion in its service environment, while maintaining its adequate mechanical and resistant properties. Different concretes require different degrees of durability depending on the exposure environment and desired properties.

### DESCRIPTION OF THE INVENTION

The present invention relates to a new cementitious composite and to a new type of cementitious materials of the mortars and concrete type with long service life, comprising submicron crystals of ettringite and portlandite after the curing period of the material. Said crystals have submicron dimensions in at least one of their dimensions, <300 nm, preferably <200 nm, and more preferably <100 nm and still more preferably <50 nm, and remain stable after 28 days of curing the material, and more preferably after 90 days of curing the material.

In this invention, two additions have been used in the examples for the formation of cementitious composites:
a) Microsilica: this compound is generated as a by-product during the reduction of high purity quartz with coal, in electric arc furnaces to obtain silicon and ferrosilicon. It consists essentially of non-crystalline silica with a high specific surface area compared to that of Portland cement. The average particle size is micrometric and corresponds to agglomerates of silica nanoparticles. At least 50% of the particles are smaller than 100 nm and contain silica particles up to 1000 nm. The state of agglomeration is such that the presence of silica particles outside the agglomerates is not significant.
b) Nanosilica or silica fume: it is a synthetic form of silicon dioxide characterized by the nanometric dimension of its particles. The material is agglomerated but the agglomerates are poorly cohesive and with different sizes of agglomerates that range from nanometric to micrometric sizes.

The physical phenomenon that takes place in the present invention is the dispersion and anchoring of oxide nanoparticles of different nature on cement microparticles forming cementitious composites. This method of dispersion takes place by the establishment of interaction forces between the surface of the particles involved, such as Van der Waals forces, they are the attractive or repulsive forces between molecules (or between parts of the same molecule) different from those due to an intramolecular bond (ionic bond, metal bond and covalent bond of reticular type) or the electrostatic interaction of ions with others or with neutral molecules. Van der Waals forces include: force between two permanent dipoles (dipole-dipole interaction or Keesom forces); force between a permanent dipole and an induced dipole (Debye forces); or force between two instantaneously induced dipoles (London dispersion forces). In the dispersion process, the proximity interactions between the surfaces of the silica nanoparticles and the other cement particles provide a modification of their surface characteristics that allow the anchoring of the silica nanoparticles on the surface of the cementitious microparticles and the resulting composite presents an improvement in functional properties.

The oxides present differences in the adsorption of OH⁻ groups from the dissociation of adsorbed water molecules in the available sites of the surface of the inorganic oxide particles. This characteristic of adsorption of OH⁻ groups is defined as the basicity of the surface and indicates quantitatively the ability to release electrons of oxygen ions, O₂, and the adsorption of OH⁻ on the surface of the oxide. The absorption capacity of OH⁻ groups on the surface of the oxides increases with the reduction of the particle size and produces an increase in the electrostatic charge of these particles. When H₂O saturation occurs in the atmosphere, water molecules form on the surface of the particles that contribute to the neutralization of the charge.

The invention contemplates a pre-drying process of the silica nanoparticles (when referring to “silica nanoparticles” both the nanosilica and the microsilica—agglomerated nanoparticles are being mentioned, as explained in the “definitions” section) for maximizing the electrostatic charge of the nanoparticles and favor the van der Walls interactions with the surfaces of the cement particles. In this way, the repulsion between the silica particles and the anchoring of these in the cement particles takes place, thus forming the dispersion of the silica nanoparticles. The anchoring of the silica nanoparticles on the surface of the cement microparticles is favored by the charge compensation between the microparticles and the silica nanoparticles. In this way, the humidity absorption capacity of the composite thus formed is modified.

The invention describes a process for obtaining cementitious composites comprising the dry dispersion of dry silica nanoparticles, at a humidity of less than 0.3% by weight with respect to the total weight, preferably less than 0.2%, more preferably at a humidity less than 0.1% and even more preferably at a humidity less than 0.05% by weight with respect to the total weight, on the cement particles. This dispersion allows the hierarchical arrangement of the particles wherein the nanoparticles of silica which have a lower proportion are dispersed on the surface of the cement microparticles which are in greater proportion. The micrometric size of the cement particles defines the available surface to house the silica nanoparticles. This mixture is used as conventional cement with good workability in the preparation of mortars and concretes, which refers to the ease with which an operator can handle the mixture and which is determined with the degree of fluidity. The degree of fluidity has been measured with the cone of Abrams and is showed in Table 8.

It is proposed the use of this mixture, cementitious composite, for mortars and concrete with properties of long life in service with a durability and high resistance to environmental agents.

The present invention relates first of all to a method for preparing a cementitious composite comprising:
1) a first conditioning step of silica nanoparticles, selected from microsilica, nanosilica and mixture of both, wherein they are heated to a temperature between 85-235° C., preferably between 130 and 230° C., more preferably between 90 and 140° C., and still more preferably between 95 and 110° C. for a period of enough time to achieve a maximum humidity content of 0.3% with respect to the total weight of the material resulting from this first step,
2) a dry dispersion step wherein the conditioned nanoparticles according to step 1) are dispersed on the cement particles and wherein inert grinding balls are used,
3) a conditioning step of the cementitious composite obtained in step 2), wherein the grinding balls used in the preparation of the cementitious composite are separated by, for example, a sieve.

According to the Invention, and for all objects thereof, “silica nanoparticles” are sets of silica particles with at least 50% particles with a size less than 100 nm.

The conditioning time of the silica nanoparticles depends on the temperature chosen and on the quantity of nanoparticles, that is, on the volume of material available. The time will therefore be the necessary to obtain a maximum humidity content of less than 0.3% by weight with respect to the total weight of the material resulting from said first step, preferably less than 0.2%, more preferably at a lower humidity of 0.1% and even more preferably at a humidity less than 0.05%, on the cement particles.

According to specific embodiments of the procedure, this comprises:
1) a first step of conditioning silica nanoparticles, in which they are heated to a temperature between 85-235° C., preferably between 90 and 230° C., more preferably between 90 and 140° C., and even more preferably between 95 and 110° C. for the time necessary to obtain a maximum humidity content of 0.05% with respect to the total weight of the resulting material,
2) a dry dispersion step, in which the silica nanoparticles conditioned according to step 1) are dispersed on the cement particles and in which inert grinding balls of zirconia stabilized with yttria of 2 mm diameter are used,
3) a conditioning step of the cementitious composite obtained in step 2), in which the used grinding balls are separated from the cementitious composite obtained using, for example, a sieve with a mesh size of 500 μm.

The silica nanoparticles—as defined above in the “definitions” section—according to the invention can have an average agglomerate size between 0.08 and 20 μm, preferably between 0.1 and 18 μm, more preferably between 0.2 and 15.0 μm. The agglomerates of microsilica particles can have an average size of between 10 and 18 μm, preferably between 12 and 15 μm.

The silica nanoparticles—as defined above in the “definitions” section—according to the invention can have a BET specific surface of between 10 and 220 m²/g, preferably between 20 and 210 m²/g, more preferably between 23 and 200 m²/g. The microsilica particles can have a BET specific surface comprised between 2 and 220 m²/g, preferably between 4 and 200 m²/g. According to specific embodiments of the method, step 1) of conditioning the raw materials comprises heating silica nanoparticles, at a temperature between 100-200° C. for a period of, for example, between 0.02 hours and 26 hours.

According to additional specific embodiments of the method in the first step, the nanoparticles are heated between 100 and 140° C., during a period, for example, between 0.1 hours and 25 hours.

The purpose of this first step of the method is to achieve an optimum heating of the powder sample in such a way that the adsorbed humidity is eliminated. Therefore, any heating system that meets this condition could be used. The equipment for carrying out this step can be, for example, a drying oven, such as a forced air drying oven by Labopolis Instruments. Any device or equipment that allows continuous microwave drying or infrared oven drying may also be used.

In the first step, the nanoparticles can be heated following ramps between 1° C. and 100° C./min, preferably between 3° C. and 50° C./min.

According to specific embodiments of the method, in the first step, nanoparticles are obtained with a humidity percentage of less than 0.3% by weight with respect to the total weight, preferably less than 0.2%, more preferably at a humidity of less than 0.1% and more preferably still at a humidity of less than 0.05% by weight with respect to the total weight, on the cement particles.

Subsequently, once obtained, the humidity absorption capacity of the nanoparticles that are anchored is modified because the surface charges have been compensated, also affecting the surface of the cement particles. Therefore the humidity does not have the same effect on the composite once obtained, that on the individual components of the same one.

In step 2) of the process the silica nanoparticles and the cement particles can be in a variable weight ratio, for example between 85 and 99.5% cement and between 15 and 0.5% particles. This process of dispersion of the silica nanoparticles on the cement particles is assisted by inert grinding balls that can be of variable diameter, and whose function is to favor the transfer of energy between the particles.

According to particular embodiments of the invention, in step 2) dry dispersion, the appropriate amount of raw materials—cement particles and silica nanoparticles (selected from microsilica, nanosilice and mixtures thereof)—necessary to form the composite, the nanoparticles previously conditioned according to step 1), they are introduced in a biconical agitation mixer where the particles impact among them. The impacts that occur between the particles in the absence of absorbed water are those that provide the necessary energy to establish the short-range interactions between the cement particles that constitute the support particles, which are the cement particles, and the silica nanoparticles for that these are scattered and anchored to the larger ones.

The equipment for carrying out the dispersion step 2) can be, for example, a mixer such as a concrete mixer or mixer, V-shaped powder mixer, drum mixer, free fall mixer, Eirich-type intensive mixer or a BC-100 biconical mixer. −CA of the LLeal company with 65 L of useful capacity.

Other types of microballs, such as zircon microballs (ZrSiO₄) or steel microballs, or mixtures thereof, can be used as grinding balls. The sizes of the microballs or grinding balls can vary between 1 mm balls to 100 mm balls. A mixture of sizes can also be used.

The grinding balls used are, according to particular embodiments, 2 mm diameter microballs of YTZ (zirconia stabilized with Ytria), ZrSiO₄ microballs, and steel microballs or mixtures thereof.

Depending on the type of mixer and the mixer charge, the stirring time in step 2) can vary, for example between 0.2 and 4 hours, preferably one hour.

A characteristic of the dry dispersion method is that there is a heating of the mixture of cement particles and silica nanoparticles as a consequence of the energy transfer. Through this heating an increase in temperature between 40-80° C. is reached.

The step 3) of conditioning of the product obtained in step 2) ensures that the finished product is not contaminated with the grinding balls and loose the possible agglomerates that may have formed due to the agitation of the materials in the mill.

The duration of this step will depend on the type of sieve and the amount of material resulting from step 2). It is a method very dependent on the dimensions of both.

According to particular embodiments in the second dispersion step, a stirring time between 0.2 and 4 hours is used.

An example of a device for performing step 3) in which the grinding balls are separated from the cementitious composite is by means of a vibrosieve of controlled and inert mesh light. Preferably, the sieve used has a mesh size of ¼ the diameter of the grinding balls. In a preferred embodiment using 2 mm diameter balls, a sieve with a mesh size of 500 μm is used.

Another example of equipment for carrying out step 3) is a sieving machine, such as a circular sieve shaker for classification of solid products from Maincer S.L. (Vibrosieve Ø 450 mm).

The present invention also relates to a cementitious composite that is obtained according to the method defined above, comprising:
cement particles and
silica nanoparticles with a total proportion of silica particles of 0.5% to 15% by weight with respect to the cement, preferably from 1% to 12% by weight with respect to the cement.

The cementitious composite of the present invention is characterized in that the silica nanoparticles are dispersed in the cement particles.

The cementitious composite according to the Invention can have variable proportions of microsilica and nanosilica, for example, according to particular embodiments, it can be selected from:
a composite with 8% of microsilica and 2% of nanosilica, and
a composite with 10% of microsilica and 0% of nanosilica.

In the cementitious composite of the Invention, the cement is selected from the usual types of cement industrially produced, such as Portland cement, Ferric Portland cement, white cement, pozzolanic cement, aluminous cement, special cements and mixtures of cements, and according to concrete embodiments the preferred cement is CEM I 52.5 R Portland type cement.

The present invention also relates to a cement-based material which in its preparation uses the cementitious composite defined above as the cement phase, and which, after 28 days of curing, also comprises ettringite and portlandite in the form of crystals of submicron dimensions.

According to particular embodiments, the cement-derived material is in the form, for example, of mortar or concrete obtained from the cementitious composite defined above, which comprises ettringite and portlandite in the form of crystals of submicron dimensions after 28 days of curing, the ettringite because it is primary ettringite and has a proportion of at least 1% by weight with respect to the total weight of the cement-based material.

According to particular embodiments of the cement-based material, the submicron dimensions of the ettringite phase comprise sizes less than 300 nm, preferably <200 nm, more preferably <100 nm and even more preferably <50 nm, in at least one of its dimensions. The percentage of primary ettringite in the material after 28 days of curing is at least 1% by weight, preferably at least 1.5% by weight, and more preferably at least 2% by weight relative to the total weight of composite. The percentage of primary ettringite in the material at 90 days of curing is at least 1% by weight.

To determine the percentage of primary ettringite, a calculation of the semiquantitative content of ettringite, defined by the acronym AFt, in the samples was made (indicated under each diffractogram in percentage), estimated from the relative intensities of the most intense diffraction maxima. The maximum values of AFt are Indicated in the diffractograms with the letter E.

This cement-based material is according to particular embodiments, mortar or concrete.

According to particular embodiments, the cement-based material is mortar and has a resistance to compression at 7 days of at least 77 MPa and a resistance to compression at 28 days of at least 90 MPa; an electrical resistivity, at 7 days of curing, of 23.1 kQ·cm; and at 28 days of curing, of 32.2 kQ·cm, and a coefficient of chloride migration at 28 days of 2.4 10⁻¹²·m²/s.

According to further particular embodiments the cement-based material is a concrete having a resistance to compression at 7 days of at least 52 MPa and a resistance to compression at 28 days of at least 60 MPa, preferably at least 67 MPa, an electric resistivity after 7 days of curing of 4 kQ·cm, preferably of at least 17.17 kQ·cm, and at 28 days of curing of 20.5 kQ·cm, preferably of at least 81.82 kQ·cm, and a maximum coefficient of migration of chlorides at 28 days of 0.7×10⁻¹²·m²/s.

The present invention also relates to a process for the preparation of the cement-based material defined above, preferably mortar or concrete, comprising:
1) obtaining a cementitious composite described above, comprising:
   cement particles and
   silica nanoparticles in a total proportion of 0.5% to 15% by weight with respect to the cement, preferably from 1% to 12% by weight with respect to the cement,
2) mixing the obtained cementitious composite with
   at least one aggregate,
   water,
   and required additional components to obtain a cement-based material. The elaboration of the concretes is carried out following a standardized procedure such as that described in the standard (UNE-EN 12390-2, 2009). There are different methods of obtaining and compositions, but the standardized method has been used in order to have data that are comparative. In the technology on cements an expert understands that from the data according to norm the methods of obtaining according to the need of the concrete application can be modified. Although there are different standards in each country, all of them are very similar.

Thus, according to preferred embodiments, the process for the preparation of the cement-based material comprises:

a) obtaining a cementitious composite described above comprising:
cement particles and
silica nanoparticles in a total proportion of 0.5% to 15% by weight with respect to the cement, preferably from 1% to 12% by weight with respect to the cement, and a percentage of residual humidity of less than 1% by weight with respect to the weight total, preferably less than 0.5% by weight with respect to the total weight, and

b) mixing the cementitious composite obtained with
at least one aggregate,
water,
and additional components needed to obtain concrete,

c) carrying out the operations according to the standard procedure to obtain a cement derivative, such as a concrete.

The manufacture of mortar specimens is carried out following the procedure described in the standard (UNE-EN 196-1, 2005) with the exception of the compaction of the samples for which 90 strokes were used. The aggregate used for the manufacture of the mortar specimens corresponds to a standardized CEN sand meeting the specifications of the standard (UNE-EN 196-1 2005).

Thus, according to further preferred embodiments, the process for the preparation of the cement-based material comprises:

a) obtaining a cementitious composite described above comprising:
cement particles and
silica nanoparticles in a total proportion of 0.5% to 15% by weight with respect to the cement, preferably from 1% to 12% by weight with respect to the cement, and a percentage of residual humidity of less than 1% by weight with respect to the weight total, preferably less than 0.5% by weight with respect to the total weight, and

b) mixing the cementitious composite obtained with
at least one aggregate,
water,
and required additional components to obtain a mortar

c) carrying out the operations according to the standard procedure to obtain a mortar, with the condition of using 90 strokes in the compaction of the samples.

According to particular embodiments of the process, the cementitious composite is selected from:
a composite with 8% of microsilica and 2% of nanosilica, and
a composite with 10% of microsilica.

The cement may be of any type, but preferably it is Portland cement particles.

The present invention also relates to the use of the cementitious composite defined above, or of the cement-based material defined above, in the construction industry.

### Advantages

The cement CEM I 52.5 R with the percentage of addition of silica nanoparticles in 10% by weight, both with microsilica and with nanosilice or the mixture of both of the present invention has given rise to materials with advantageous durable properties and mechanical resistance, even at an early period of 7 days of curing. Undoubtedly, mortars with better mechanical properties have been prepared with this percentage of addition, with the additional feature that when a part of the addition is nanosilica, even in small proportions, the pore upholstery with primary ettringite size stable nanoscale after the curing of the mortar increases, which is advantageous for the durable properties of said materials.

An example of this are the excellent properties found for the case of 8% microsilica+2% nanosilica, especially in regard to durable aspects, for which very high resistivity values are obtained (81.8 kQ·cm) and an extremely low chloride migration coefficient (0.761×10⁻¹²·m²/s).

The method of the present invention, by dry dispersion, is a very efficient method of preparing cement-based materials, especially as regards the durable properties. In addition, it supposes a method that guarantees the hygiene and health in the work, avoiding the harmful effects that can cause the inhalation of so small particles due to the fact that the nanoparticles of silica are anchored in the microparticles of cement. In this way, the cementitious composite of the present invention can be handled and used as standard cement without special requirements for manipulation of nanomaterials.

The presence of primary ettringite in the cement-based materials of the present invention after curing allows achieving characteristics in the material that represent significant advantages such as the following values in standardized mixtures:
Decreased connected porosity with total porosity values of less than 10%.
Acceleration of pozzolanic reactions at low curing ages with higher percentages of C—S—H gel.
Better adhesion between the aggregate and the cementitious paste.
Rapid hardening with values of up to 60 MPa to 7 days for mortars from cementitious composites of the invention with cements 52.5R, and up to 80 MPa at 7 days for mortars of the invention with CEM I 52.5R cements in standardized mortars (water/cement ratio equal to 0.5).
Values of up to 80 MPa at 28 days for mortars from resistant class 52.5R cements and up to 100 MPa at 28 days for CEM I 52.5R cement in standardized mortars (water/cement ratio equal to 0.5).
Applicable to mortars and/or concrete.
Long durability of concrete with very high resistivity values (81.8 kQ·cm) and an extremely low chloride migration coefficient (0.761×10⁻¹²·m²/s).
Long life in concrete service with calculated values over 800 years.
It adapts to different types of cements.
It combines the inclusion of micro and nanoparticles of different nature in a simple method of single dosage to cement that minimizes the variables of manipulation by operators.
It reduces costs by allowing the use of nanoparticles in standardized methods with the production of cement particles.
High workability in forming mortars with absence of organic additives such as superplasticizers and in concretes with reduction of organic additives as superplasticizers.
Method that guarantees hygiene and health at work, avoiding the harmful effects that the inhalation of nanometric particles can cause.

### BRIEF DESCRIPTION OF THE FIGURES

FIG. 1 shows Scanning Electron Microscopy, SEM, micrographs of cement 52.5R.

FIG. 2 shows SEM micrographs of the cementitious composite of the invention with 10% nanosilica.

FIG. 3 shows SEM micrographs of cement with 10% FE, this is 10% of microsilica of the company Ferroatlántica S.L.

FIG. 4 shows a SEM micrograph of the M-3.2 mortar sample after 7 days of curing, where it can be observed the interior of a pore covered with nanometric ettringite.

In FIGS. 5a), 5b) and 5c) MEB micrographs of M-3.2 mortars at 28 days of age of curing, with different scales are presented, where it can be observed the Interior of a pore clearly covered by nanometric ettringite needles which remain stable.

FIGS. 6a) and 6b) show SEM micrographs for the dosing of concrete sample H-3.1 after 28 days of curing, in which it is observed that the reduction does not occur when the addition is of micrometric size.

FIG. 7 shows the SEM micrograph of H-3.3 concrete after 28 days of curing, where nanometric ettringite needles can be seen.

In FIGS. 8 a) and 8b) the ettringite crystals are observed next to the C3A formations, in SEM micrograph of the H-3.2 concrete after 28 days of curing.

FIG. 9 shows a X-ray diagram of H-1 at 90 days with a percent ettringite of <0.5% with respect to the total mass.

FIG. 10 shows a X-ray diagram of H-3.1 at 90 days with a percent ettringite of 1.6% relative to the total mass.

FIG. 11 shows a X-ray diagram of H-3.2 at 90 days with a percentage of ettringite of 2.4% with respect to the total mass.

FIG. 12 shows a XRD diagram of H-3.3 at 90 days with a ettringite percentage of 1.5% relative to the total mass.

FIG. 13 shows Raman spectra of the starting materials used C1 and microsilica and of the cementitious composite systems CC3.1 and CC3.0.8.

FIG. 14 shows Raman spectra of a selected area between 830 and 870 cm⁻¹ for cement C1 and cementitious composites CC3.1 and CC3.0.8. The discontinuous vertical lines have been included as a visual guide to highlight the shift of the Raman bands.

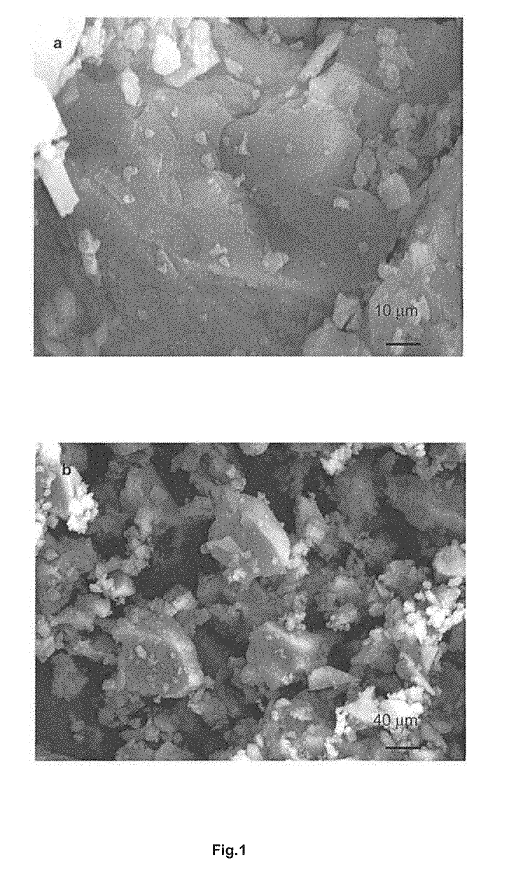

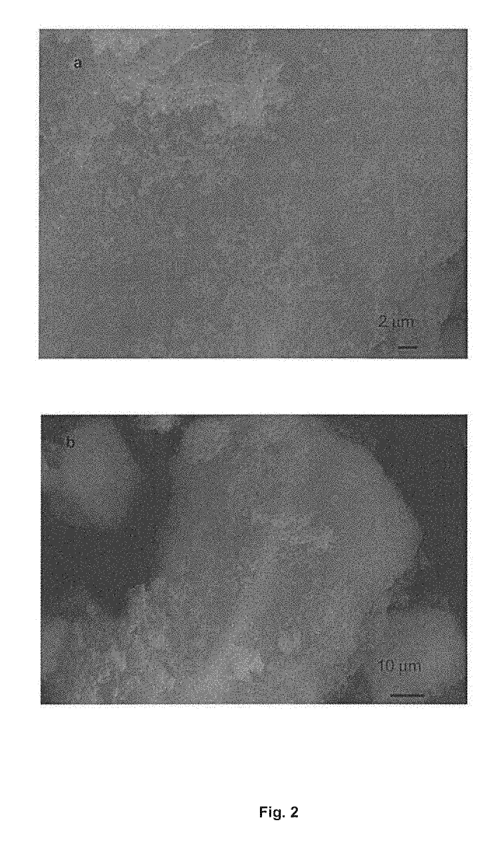

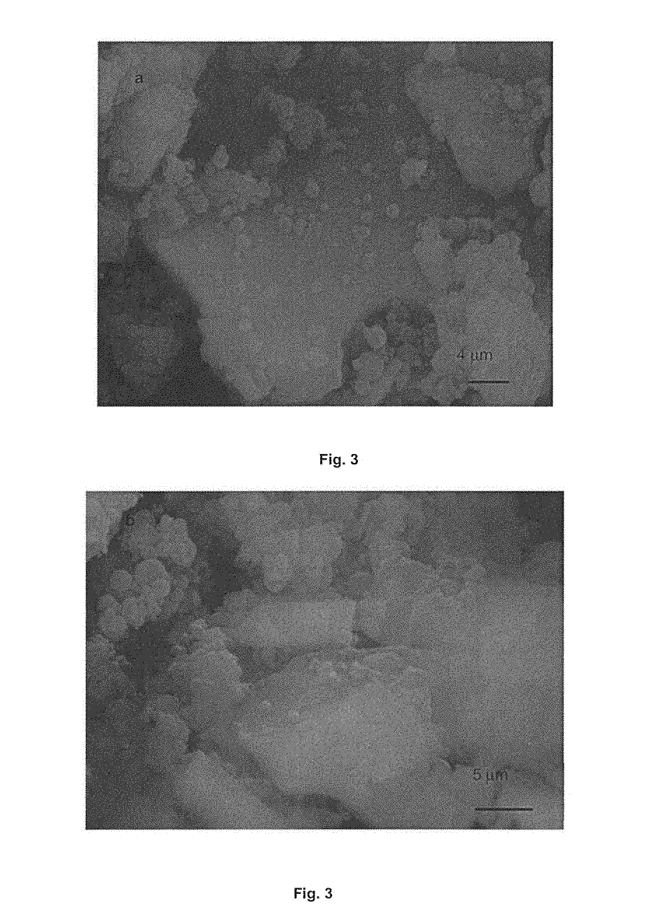

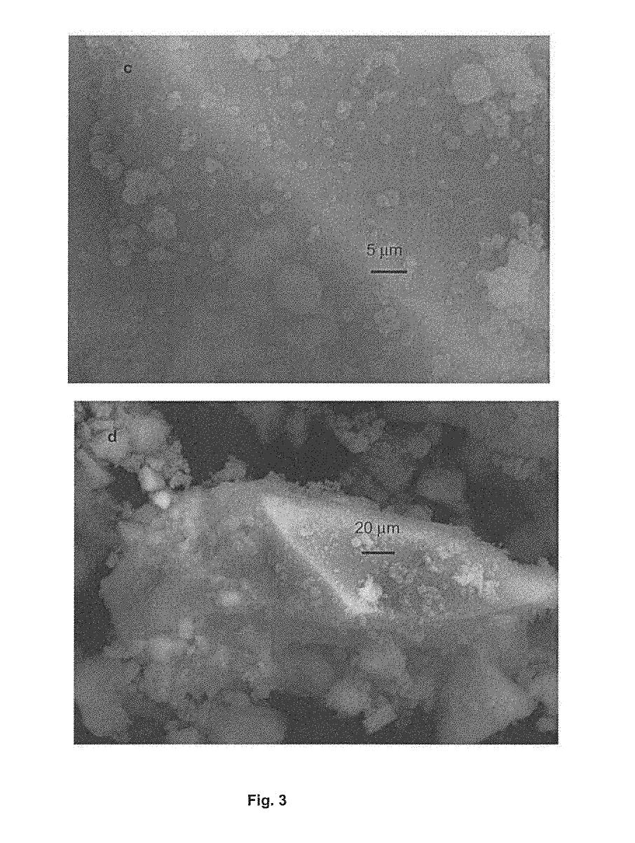

### Examples

### Example 1. Preparation a Cementitious Composite

Table 1 shows the physical and chemical characteristics of the cement used, provided by the manufacturer. Table 2 shows the granulometry of said cement.

TABLE 1
Physical and chemical characteristics of the cement used

| | | Standard |
|---|---|---|
| Chemical characteristics (%) | Results | EN/UNE |
| Lost by calcination/Lost by fire | 1.60 | <5 |
| Insoluble Residue | 0.3 | <5 |
| Sulfates (SO₃) | 3.10 | <4 |
| Chlorides | 0.01 | <0.10 |

Physical and chemical characteristics

| | | | |
|---|---|---|---|
| Normal consistency water | % | 35.3 | |
| Start setting | min | 90 | >45 |
| Final setting | min | 127 | <720 |
| Le Chatelier expansion | mm | 0.8 | <10 |
| Specific surface (Blaine) | cm²/g | 7470 | |

TABLE 2
Granulometry of the cement used
Granolometry (% that passes trough)

| | |
|---|---|
| Sieve 1 Micron | 14.0 |
| Sieve 8 Micron | 61.0 |
| Sieve 16 Micron | 88.0 |
| Sieve 32 Micron | 99.8 |
| Sieve 64 Micron | 100 |
| Sieve 96 Micron | 100 |
| Average Dimeter (Micron) | 5.7 |

Table 3 shows the specific surface and the average particle size.

TABLE 3
Specific surface and average particle size of the additions used

| | Nanosilica | Microsilica |
|---|---|---|
| BET Specific Sufarce (m²/g) | 200 | 23 |
| Average size (μm) | 0.2-0.3 | 15.0 |

### 1—Drying of Silica Nanoparticles

In a specific example, in the conditioning step of raw materials, 200 grams of nanosilica or microsilica are heated, or a mixture of both at a temperature between 100-200° C., preferably 120° C., for 24 hours, in order to eliminate humidity adsorbed on the silica nanoparticles. This step is critical for the proper dispersion and anchorage of the smaller particles. In another test of the conditioning step, it was found that I gram of nanosilica, or 1 gram of microsilica, or a mixture of both, dried effectively in a heating at 120° C. for 5 minutes with ramps of 20° C./min on an infrared balance.

Similar treatments to 140, 160 and 180° C. for a similar time have given the same result but require a greater energy consumption to heat the material.

Preferred conditions for some embodiments were 100° C.—24 hours.

In other examples, the cement microparticles were also dried. However, this process is not necessary and it was found that the same results were obtained without the drying process of the cement particles, since the water absorbed in the cement is not removed by drying as it reacts forming hydrated compounds.

### 2. Dry Dispersion Process

In a particular example, weight proportions of 90% of cement particles CEM I 52, 0.5R and 10% of nanosilica or microsilica are used, or 10% of a mixture of both; for example 8% microsilica and 2% nanosilica.

The appropriate amount of raw materials necessary to form the composite, the silica nanoparticles being previously conditioned, is introduced in a biconical agitation mixer where some particles impact with others. This agitation process is assisted by inert grinding balls of stabilized zirconia with yttria of 2 mm in diameter that helped to generate a greater energy transfer between the particles. The weight ratio between grinding balls and the cement particles used was 1 to 2.

A biconical mixer of 10 L of useful capacity has been used, constructed in stainless steel AISI-316-L for all the parts in contact with the product. The mixer was mounted on a carbon steel bedplate, dimensioned to allow a useful distance of the 800 mm ground discharge valve.

### 3. Conditioning of the Cementitious Composite

In this step, the grinding balls of the product were separated by means of a 500 μm vibrosieve of stainless steel light mesh, which ensures that the finished product does not contain grinding balls and also allowed to reduce the possible agglomerates formed due to the agitation of the materials in the mill when releasing said agglomerates.

The conditioning step of the final product or product obtained in step 2) of dispersion was carried out by means of a circular sieve screen for classification of solid products of Maincer SL, suitable for sifting from 36 μm to 25 mm. The sifter has a product inlet in the central part and outlet through the side mouth and is made entirely of stainless steel. It has a vibrating motor with eccentric masses.

The product was sieved until the grinding balls used are clean and all the agglomerates have been discarded.

Optionally, the balls can be Inside the mixing system if there is a suitable separating element that allows the exit of the composite microparticles and retain the microballs.

### Example 2. Preparation of Mortar Using Cementitious Composite

For the preparation of the mortar specimens, CEM I 52, 0.5R cement particles were used, supplied by the Cementos Portland Valderrivas Group and manufactured according to the standard (UNE-EN-197-1: 201 1). The characteristics of the cement used are shown in table 1 and 2 above.

Two different additions were used for the mortars: Microsilica supplied by Ferroatlántica S.L and nanosilica powder CAB-O-SIL M-5 supplied by CABOT.

The aggregate used for the manufacture of the mortar specimens was a standardized CEN sand meeting the specifications of the standard (UNE-EN 196-1 2005).

For the tests of mortars, standardized prismatic samples of 40×40×160 mm were manufactured. The manufacture of these mortar specimens was done according to the procedure described in the standard (UNE-EN 196-1, 2005) with the exception of the compaction of the samples for which 90 strokes were used. The amount of cement particles and the water/cementitious material (w/c) ratio is 0.5, the one specified in the same standard. In the cases in which additions of silica nanoparticles were introduced to obtain the cementitious composite, the amount of cement as a cementitious composite was considered, that is, the silica nanoparticles replaced the cement. In this way, the water/cementitious composite ratio was maintained at a value of 0.5. After 24 hours in the mold in a laboratory environment covered by a damp cloth to prevent drying, the test pieces were demolded and cured submerged in water, maintaining it at (20±1) ° C.

Two methods of including the silica nanoparticles into the mixture were compared. The first one was to add the silica nanoparticles during the kneading process; that is, the conventional method called as manual method of including silica nanoparticles. In the second method the silica nanoparticles were added using the method object of the present invention described above in the section “description of the invention” and the examples of preparation of cementitious composite, which achieves a dry dispersion of the silica nanoparticles on the cement particles. This mixture is used as conventional cement with good workability in the preparation of mortars and concretes.

Dosages with different content of silica nanoparticles were tested. In the dosages prepared in a conventional manner for comparative purposes, it was necessary to add a superplasticizer additive to improve the workability of the mortars.

The best results in mechanical and durable properties were obtained for the dosages with 10% of silica nanoparticles, being the optimum in the durability properties in the combined addition of microsilica and nanosilica, in proportions of 8% of micro and 2% of nanosilice. This mixed addition dosage was only possible with the material obtained using the method of the present invention, since manual mixing was impossible given the enormous demand for water that it required. In the manual mixture it was not possible to avoid the use of the superplasticizer additive in proportions lower than 5% with respect to the weight of cement that allows, at most, the standard. The mixture made by the manual method of including silica nanoparticles, was impossible to knead, even with the maximum content of superfluidizer additive. Following the conventional method of addition of silica nanoparticles, it was only possible to perform the mixture with 10% addition of microsilica. In the following, the results of the different tests of mechanical and durable properties that have been carried out will be presented for the following dosages:
M1, reference dosage made with CEM I 52.5R cement particles without any addition.
M2, conventional dosage with the same cement and manual addition of 10% of microsilica.
M-3.1, dosage with the same cement and addition of 10% of dispersed micro silica with the method of the invention.
M-3.2, dosage with the same cement and addition of 8% of micro silica and 2% of nano silica dispersed with the method of the invention

The resistance to compression is used as the main mechanical characteristic of cementitious materials. The compression resistance test was performed according to the standard (UNE-EN 196-1, 2005). At the ages of 7 and 28 days, six semiprisms of 3 test tubes of 4×4×16 cm obtained previously to the bending break of each prepared dosages, were broken. The testing machine used was an Ibertest 150 T hydraulic press with Servosis automation. The results found for this test carried out in the mortar are shown in table 4:

TABLE 4
Resistance to compression at 7 and 28 days of the dosages used

| | Resistance to | Resistance to |
|---|---|---|
| | compression at | compression at |
| Sample | 7 days (MPa) | 28 days (MPa) |
| M-1 | 59 ± 2 | 67 ± 1 |
| M-2 | 62 ± 3 | 80 ± 1 |
| M-3.1 | 81 ± 3 | 97 ± 4 |
| M-3.2 | 77 ± 3 | 89 ± 2 |

As can be seen in table 4, the additions of microsilica and nanosilica improve the mechanical properties with respect to the mortar without addition used as a reference. The improvement is superior in the case of the use of the materials object of invention. Regarding this property the mortar made with 10% of microsilica provides better results, reaching 100 MPa in some samples made with the cement prepared with the particle dispersion method of the present invention. This method represents an improvement of more than 20% on samples made with the same addition amount included manually. In the case of the dosage made with mixed addition of microsilica and nanosilica with the method of the invention, lower values were obtained than for the 10% of microsilica added also with the method of invention, but higher than the mixture in which it was added in a manual way. On the other hand, in the measurements carried out of durable properties, better results were obtained in the M-3.2 mortar.

The fundamental parameters measured to assess the durability of the samples were electrical resistivity and migration of chlorides.

Table 5 shows the average values of the cell constant (K), electrical resistance (Re) and electrical resistivity (pe) for the mortar specimens selected at the curing age of 7 and 28 days of curing. Also included is the risk of chloride penetration for the calculated average value of electrical resistivity because both parameters can be related. This correlation can be obtained from the chloride penetration risk data dictated by the ASTM C12012 standard.

TABLE 5
Average values of the cell constant (K), electrical resistance
(Re), electrical resistivity (pe) and risk of chloride penetration
for the selected mortar specimens at 7 and 28 days of curing

| | | Age | Electric | Electric | Risk of |
|---|---|---|---|---|---|
| | K = S/L | curing | Resistance | Resistivity | penetration |
| Sample | (cm) | (days) | (kΩ) | (kΩ · cm) | Cl⁻ |
| M-1 | 5.10 | 7 | 0.728 | 3.71 | High |
| | | 28 | 0.817 | 4.17 | High |
| M-2 | 5.61 | 7 | 1.135 | 6.40 | Moderate |
| | | 28 | 2.075 | 11.6 | Low |
| M-3.1 | 5.99 | 7 | 0.823 | 4.93 | High |
| | | 28 | 3.300 | 22.02 | Low |
| M-3.2 | 5.90 | 7 | 3.915 | 23.1 | Very low |
| | | 28 | 5.460 | 32.2 | Very low |

Table 6 shows the coefficient of migration of chlorides (Dnssm) at the age of curing of 28 days for the selected mortars.

TABLE 6
Chloride migration coefficient (Dnssm) after
28 days of curing for the selected mortars

| Sample | Dnssm (10⁻¹² · m²/s) |
|---|---|
| M-1 | 13.687 |
| M-2 | 4.862 |
| M-3.1 | 2.879 |
| M-3.2 | 2.476 |

By means of the scanning electron microscopy technique, SEM, the different mortars prepared at the age of 7 and 28 days of curing were analyzed and characterized. In these samples, the different hydration products of the mortars were also identified. The morphology of the originating C—S—H gels, the phases inside the pores, as well as the morphology and phase sizes such as portlandite and ettringite were studied. In addition, the changes originated by the inclusion of the additions to the matrix of the mortar samples and the Interface or transition zone (ITZ) between the aggregate and the paste of the samples have been studied.

In the cementitious materials of the mortar type proposed by the present invention, in the case of the addition of nanosilica, ettringite and portlandite nanocrystals originated during the hydration of the material are formed. The permanence of nanometric ettringite crystals covering the pores of the hardened material represents a significant advantage, both in terms of stability against sulphate attacks and against the entry of aggressive agents through the porous network. In this way, we obtain a mortar with exceptional durability characteristics and therefore with a very long expected life.

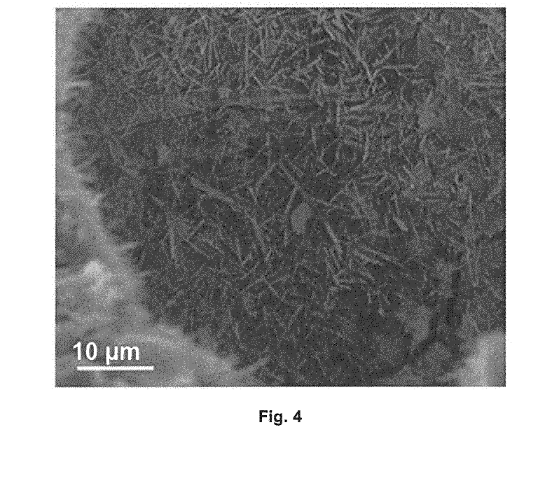

FIG. 4 shows a SEM micrograph of M-3.2 sample at 7 days of age of curing, where it can be observed the Interior of a pore covered by primary nanometric ettringite.

FIG. 5a) b) and c) show SEM micrographs (of the sample M-3.2) at 28 days of age of curing with different scales, where the interior of a pore can be observed, clearly upholstered with nanometric ettringite needles which remain stable.

For the mortars made from cementitious composites of the present invention, prepared with additions of silica nanoparticles on CEM I 52.5R anhydrous cement, it is observed that:
All of them increase their values of resistance to compression with respect to the sample without additions used as a reference, as well as on the samples in which the addition of nanosilice and microsilica was carried out in a conventional manner, the best being 10% micro-nanosilica, and 8% microsilica+2% of nanosilica at the age of 28 days of curing.
All of them lead to higher percentages of hydration degree and C—S—H gel, the general trend being the decrease of the dehydroxylation percentages.
A refinement of the porous structure is obtained in all cases with lower values of the chloride migration coefficient and higher electrical resistivities.
Scanning electron microscopy (SEM) images show more compact and dense gels than in the CEM I 525R cement reference mortar without additions, as well as a better adhesion between the paste and the aggregate. In the samples with nanosilica, an upholstery of micrometric primary ettringite is observed in the internal walls of the pores, that does not appear for the microsilica or in the reference mortar.

It stands out that for 28 days of curing the micrometric primary ettringite phase remains unchanged. This effect is particularly remarkable, since it shows that this phase does not degrade, which means an improvement in durability against attack by sulfates. Usually the primary ettringite phase formed during the hydration of the cements is not stable and goes into a monosulfate state, with less sulphate content, thus being susceptible of being attacked by the entrance of sulfates from the outside, reacting with it to give again hydrated calcium trisulfoaluminate in hardened state, which is called secondary ettringite. The formation of secondary ettringite produces a large increase in volume inside the hardened material, an effect that causes great internal stresses, and as a consequence causes an important cracking and degradation of the material.

### Example 3. Preparation of Concrete Using Cementitious Composite

For the manufacture of the concrete specimens, three dosages were selected among those studied that gave better results in paste and mortar. These were prepared with the same cement particles (CEM I 52.5R). In addition, concrete was prepared only with cement, to be used as a reference (H-I) against the mixtures under study. The compositions selected were the following, in all those that had addition, this was included by the method of the present invention:
H1, reference dosage made with CEM I 52.5R cement particles without any addition.
H3.1, dosage with the same cement and addition of 10% of microsilica.—H3.2, dosage with the same cement and addition of 8% of microsilica and 2% of nanosilice
H3.3, dosage with the same cement and addition of 10% nanosilicate.

Table 7 shows the dosages used for the manufacture of concrete specimens.

TABLE 7
Dosing for one cubic meter of concrete
of the concretes object of study

| Materials (kg/m3) | H-1 | H-3.1 | H-3.2 | H-3.3 |
|---|---|---|---|---|
| CEM I 52.5R CEM U | 400 | 360 | 360 | 360 |
| Microsilica (g) | — | 40 | 32 | — |
| Nanosilica (g) | — | — | 8 | 40 |
| Water (L) | 180 | 180 | 180 | 180 |
| Sand (kg) | 825 | 825 | 825 | 825 |
| Grit (kg) | 419 | 419 | 419 | 419 |
| Gravel (kg) | 524 | 524 | 524 | 524 |
| Superplastisizer(% with respect | 0.90 | 1.00 | 1.80 | 5.00 |
| to the weight of cement) | | | | |
| w/c | 0.45 | 0.45 | 0.45 | 0.55 |

w/c: water/cement

The elaboration of the same was carried out under laboratory conditions with temperatures of 20-25° C. and average relative humidity of 35%. The procedure used is that described in the standard (UNE-EN 12390-2, 2009). Before weighing the quantities of material indicated for the different dosages obtained, it was necessary to make the relevant corrections in the aggregates, calculating the humidity at the time of use. Once these values were obtained, the final weights of both the aggregates and the mixing water were corrected. To mix the materials, a 100-liter vertical shaft kneader with a mobile container was used to receive the concrete discharge.

Once the mixture was homogenized, the anhydrous cement particles were included with the additions previously deposited. Once the anhydrous cement was included, it was kneaded for 60 seconds with the aggregates to homogenize the material. Then, the new generation superfluidizer additive previously dissolved in a small amount of the mixing water was added to the mixture. The remaining water was included slowly. Once the batch was completed, two types of cylindrical molds were filled in 3 tons with the concretes prepared to obtain cylindrical specimens with a diameter of 150 mm and 300 mm in height and specimens of 100 mm in diameter and 200 mm in height. For the compaction of the concrete samples a vibrating table was used. After 24 hours in a laboratory environment, covered by a damp cloth to prevent drying, the specimens were demolded and cured under water until the ages of 7 and 28 days.

Prior to the filling of the molds, the Abrams cone test was carried out, which is a measure of the docility (workability) of the concrete. The results obtained are presented in table 8.

TABLE 8
Abrams Cone Seat for the dosages used
Concrete Samples

| Designation | H-1 | H-3.1 | H-3.2 | H-3.3 |
|---|---|---|---|---|
| Seat (cm) | 10 | 11 | 6 | 0 |

These results show the Impossibility of putting H-3.3 concrete into operation, due to its zero-value seat.

In table 9 the results of the compression test are shown after 7 and 28 days of curing the manufactured dosages.

TABLE 9
Average compression resistance and its corresponding standard
deviation for the concrete samples under study

Resistance to compression (MPa)
Curing time (days)

| Sample | 7 | 28 |
|---|---|---|
| H-1 | 44.8 ± 3.1 | 50.4 ± 1.5 |
| H-3.1 | 46.5 ± 0.2 | 56.3 ± 0.4 |
| H-3.2 | 51.5 ± 5.3 | 66.9 ± 0.1 |
| H-3.3 | 49.5 ± 6.1 | 52.9 ± 1.1 |

The test of resistance to compression at the ages of 7 and 28 days of curing on the concrete specimens was carried out following the standard (UNE-EN 12390-3, 2009). To carry out this test, concrete specimens of 150 mm in diameter and 300 mm in height were used.

Table 10 shows the average values of the cell constant (K), electrical resistance (Re) and electrical resistivity (pe) for the concretes under study at the curing age of 7 and 28 days. In addition, the risk of chloride penetration is included for the calculated average value of electrical resistivity in each case.

TABLE 10
Average values of the cell constant (K), electrical resistance
(Re), electrical resistivity (pe) and risk of chloride penetration
for the selected mortar specimens at 7 and 28 days of curing

| | | Age | Electric | Electric | Risk of |
|---|---|---|---|---|---|
| | K = S/L | curing | Resistance | Resistivity | penetration |
| Sample | (cm) | (days) | (kΩ) | (kΩ · cm) | Cl⁻ |
| H-1 | 3.95 | 7 | 1.272 | 5.02 | High/Moderate |
| | | 28 | 2.090 | 8.25 | Moderate |
| H-3.1 | 3.93 | 7 | 2.202 | 8.65 | Moderate |
| | | 28 | 10.581 | 41.58 | Very low |
| H-3.2 | 3.93 | 7 | 4.370 | 17.17 | Low |
| | | 28 | 20.820 | 81.82 | Very low |
| H-3.3 | 3.97 | 7 | 5.930 | 23.54 | Very low |
| | | 28 | 7.075 | 28.09 | Very low |

Another test that characterizes the durability of concrete versus the penetration of chlorides is the determination of the migration coefficient. The concrete samples under study underwent the corresponding test according to the NT-BUILT 3040 standard. The results are shown in table 11. They are observed to show the same trends found in the resistivity test. According to these results and applying the models of proposed useful life, the EHE (Spanish Instruction for Structural Concrete), and the equivalences between the coefficients of migration and diffusion of chlorides, a useful life value is obtained that is also included in the same table.

TABLE 11
Average value of the chloride migration
coefficient of the concrete studied

| | Migration | Diffusion | Service life (years) |
|---|---|---|---|
| | coefficient 10⁻¹² | coefficient 10⁻¹² | (from commissioning |
| Dosage | (m²/seg) | (m²/seg) | to the start of corrosion) |
| H-1 | 10.089 | 2.775 | 72 |
| H-3.1 | 1.91 | 0.554 | 336 |
| H-3.2 | 0.761 | 0.271 | 801 |
| H-3.3 | 2.017 | 0.583 | 319 |

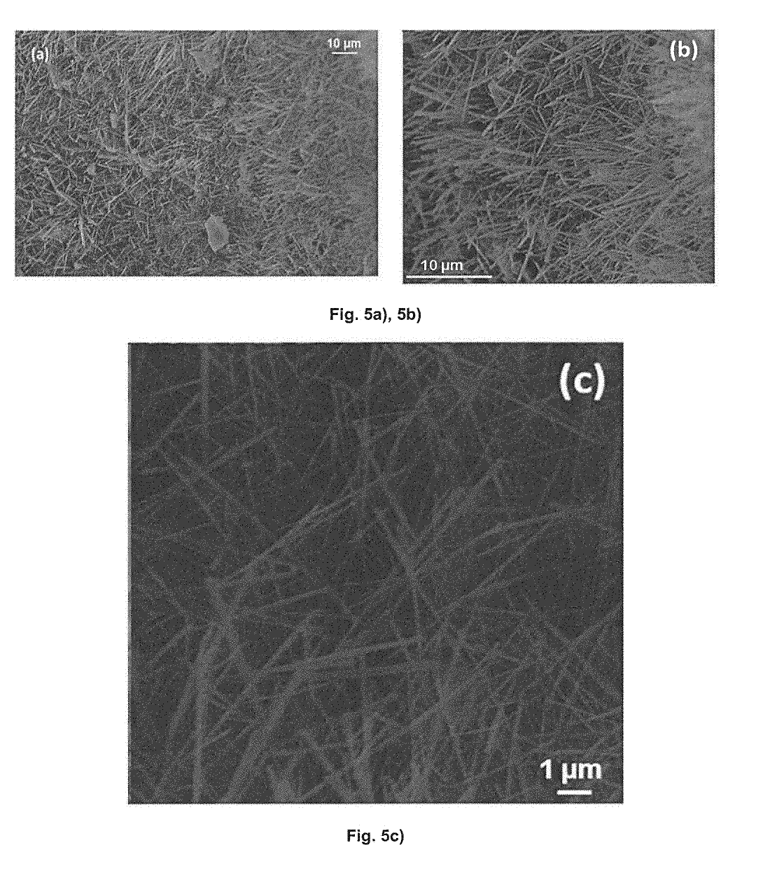

The results by SEM micrographs show that the addition of silica nanoparticles significantly reduces the size of the crystals. The SEM micrographs presented in FIGS. 6a) and 6b) for the H-3.1 dosing after 28 days of curing, and show that the reduction of the size of the crystals does not occur when the addition is of micrometric size.

In FIGS. 6a) and 6b) SEM micrographs of the H-3.1 concrete are shown.

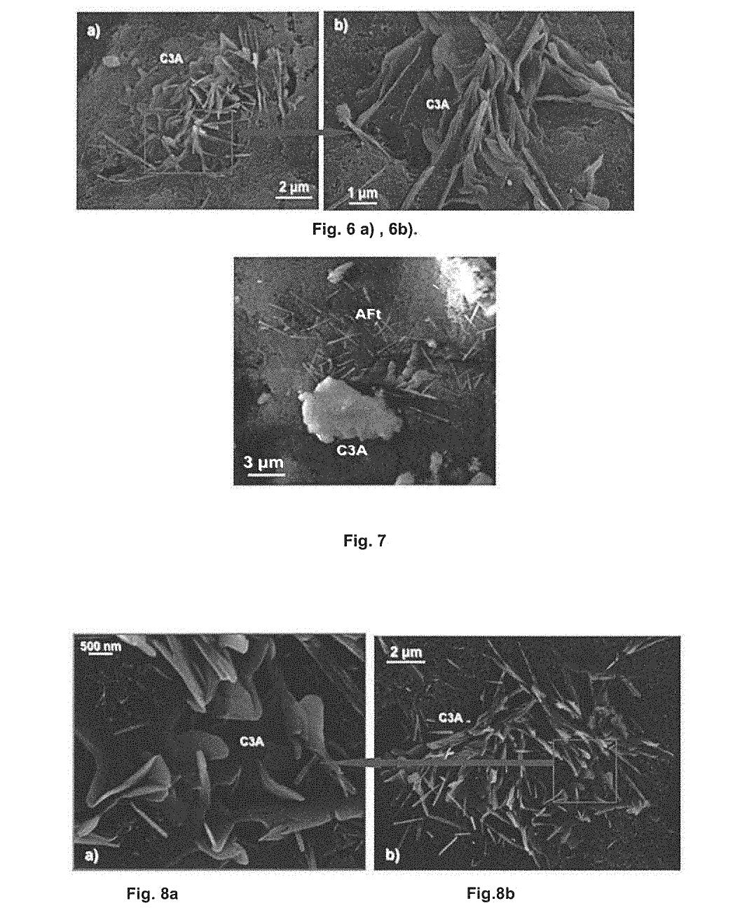

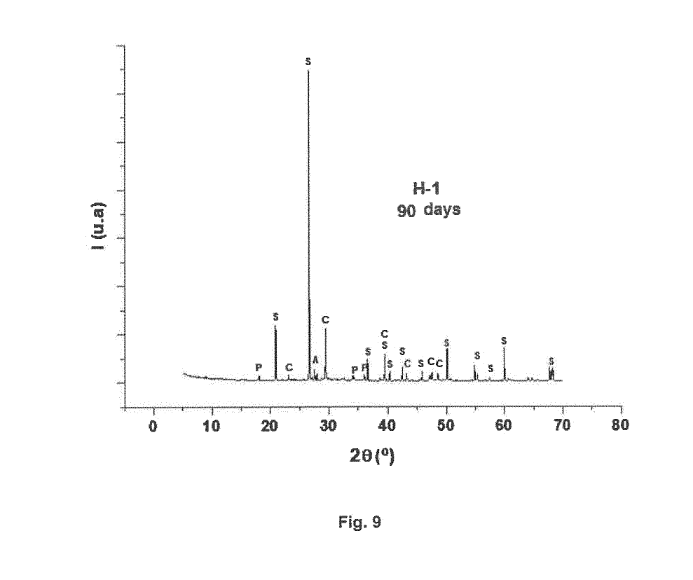

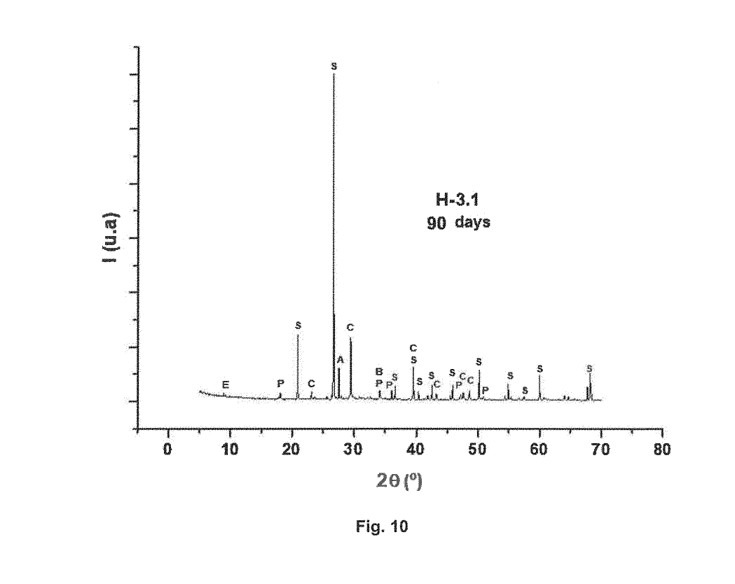

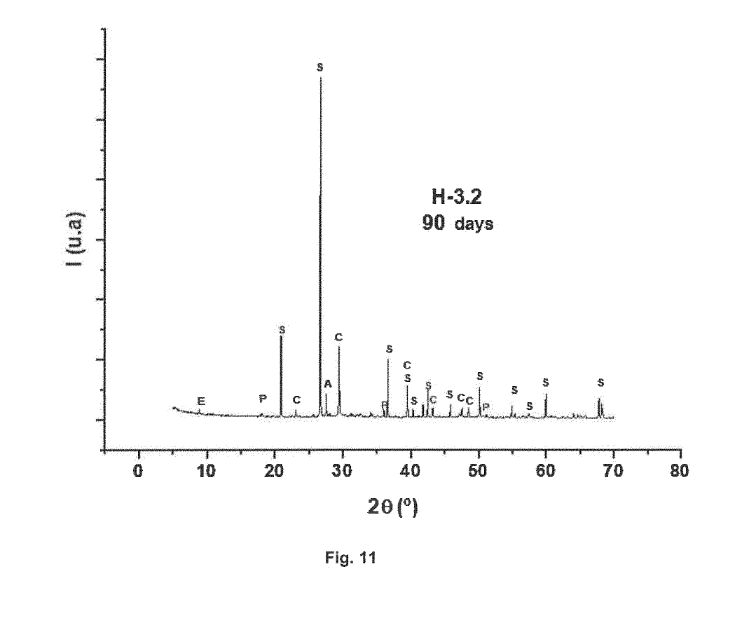

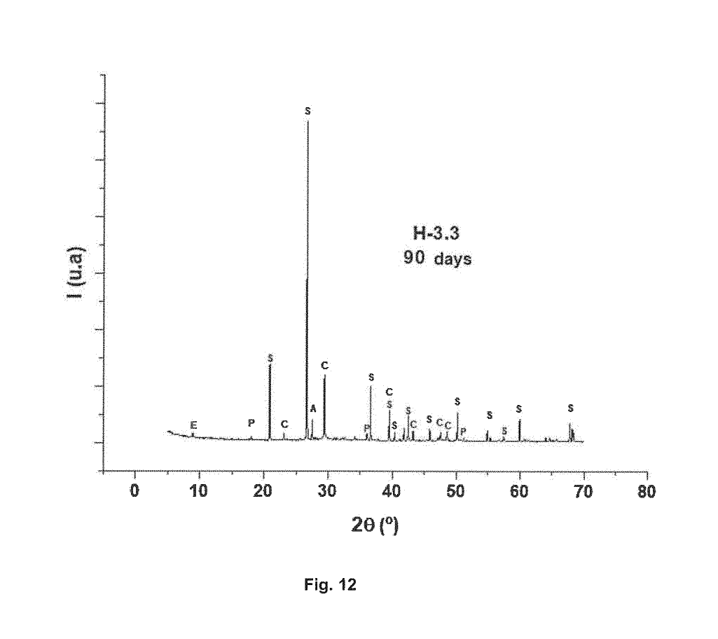

FIG. 7 shows the micrograph of H-3.3 concrete after 28 days of curing, where nanometric ettringite needles can be seen.

In FIGS. 8 a) and 8b) the ettringite crystals are observed next to the C3A formations of the H-3.2 concrete after 28 days of curing.

The micrographs show that the properties of the crystals obtained with the use of nano additions are maintained, improving the microstructure of the material and doubling its life in service.

The concrete samples obtained with similar addition of microsilica and nanosilica but following a conventional process for comparative purposes, necessarily had to be limited to the possibility of working the material. It was impossible to work with nanosilica additions greater than 7.5% by weight of the cement. Even so, in this dosage, the amounts of superplasticizing additive necessary to be able to obtain adequate workability, exceed the limit allowed by the EHE (Spanish Instruction for Structural Concrete).

The studies carried out on concrete samples with additions of micro, nano, and micro and nanosilica mixture gave better results, indicating that all cases give rise to samples with better mechanical and durable properties than the corresponding conventional concrete used as reference. The improvement of mechanical properties can be related to higher contents of C—S—H gel and higher degree of hydration than the concrete used as reference. On the other hand, the improvement of durable properties can be related to the formation of a more refined and consolidated porous structure, noticeably greater electrical resistivities, and rather lower chlorides migration coefficients. Lower percentages of portlandite also appear as significant improvements, which Is the hydrated compound more susceptible to be leached, together with a better adhesion between the aggregate and the pulp.

In summary, in all of them a notable quantitative leap in the relevant parameters of their potential mechanical properties and especially in the durable ones was observed.

With the method of the present invention, concretes having percentages of ettringite of at least 1.5% at 90 days have been obtained.

### Example 4. Characterization of the Cementitious Composite of Example 1

The materials obtained following the method described in Example 1 using both, the same starting cement and the microsilica and nanosilica, were characterized in terms of specific surface area and Raman spectroscopy.

In all cases, the drying materials were dried in an oven at 90° C. for 12 hours until they reached a humidity of less than 0.05%.

Cements, C, and cementitious composites, CC, prepared were:
C1, cement CEM I 52.5R without any addition.
C2, cement CEM I 52.5R and manual addition of 10% by weight of microsilica.
CC3.1, CEM cement 1 52.5R and addition of 10% of dispersed microsilica with the method of the invention.
CC3.2, CEM cement I 52.5R and addition of 8% of microsilica and 2% of nanosilice dispersed with the method of the invention

Additionally, and following the same procedure described in Example 1, the C2b and CC-3.1 cementitious composite were prepared from the same cement as in Example 1 and a microsilica from Elkem Microsilica® Grade 940 with a specific surface area of 20.4 m²/g:
C2b, cement CEM I 52.5R and manual addition of 10% by weight of microsilica.
CC3.1 b, CEM cement I 52.5R and 10% addition of dispersed micro silica, with the method of the invention.

In the preparation, drying of the starting materials was carried out, consisting of drying in an oven at 90° C. for 12 hours until it reached a humidity of less than 0.05%.

Table 12 shows the values of the specific surface area determined by the BET method (Brunauer, Emmett and Teller) multipoint for these materials and the % variation corresponding to the percentage of variation of the experimental area compared to the theoretical value obtained by the rule of mixtures with respect to the specific surfaces of the components of the mixture weighted by the composition of the mixture.

TABLE 12
BET specific surface of cementitious composites

| | | | % decrease of |
|---|---|---|---|
| | Mortar of | | specific surface |
| Cements and | example | | value in relation to |
| cementitious | 2 where it | BET Specific | the calculated value |
| composites | is used | Surface (m²/g) | using the mix rule |
| C1 | M-1 | 1.34 | — |
| C2 | M-2 | 3.48 | 0.75 |
| CC3.1 | M-3.1 | 3.41 | 2.74 |
| CC3.2 | M-3.2 | 6.63 | 8.23 |
| CC3.1b | — | 3.18 | 2.00 |
| CC3.2b | — | 2.82 | 13.23 |

The cementitious composites of the present invention are characterized by a decrease in the specific surface area of the composite that is >2% higher than the value of the specific surface calculated by the mixing rule. The decrease in the value of the specific surface area with respect to the value calculated by the mixing rule for the cementitious composites of the present invention is at least three times the value of the decrease of the specific surface area with respect to the value calculated by the mixing rule for a material of similar composition prepared by a manual mixing procedure. The greater decrease of the values of the specific surface area with respect to the value calculated by means of the rule of mixtures for the cementitious composites correlates with an effective dispersion of the microsilica particles and also implies a variation of the hydration capacity of the surface. The addition of nanosilica to the cementitious composite also results in a greater decrease in the value of the specific surface area compared to the value calculated by the mixing rule.

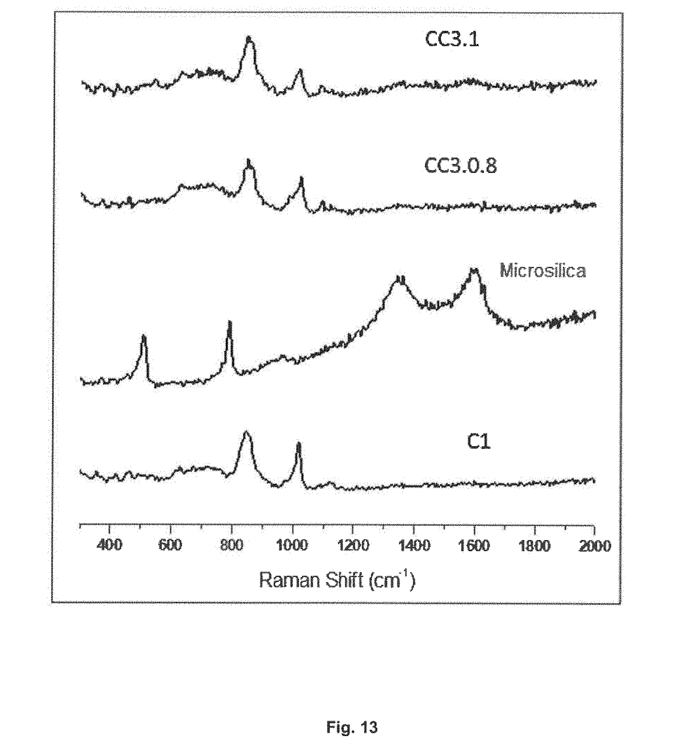

The effective dispersion of the microsilica particles or of the silica nanoparticles or of the combination of microsilica particles plus nanosilica nanoparticles is associated with a modification of the structure of the cementitious composite. This modification of the structure in the cementitious composites of the present invention is characterized by changes in the bands obtained by spectroscopy and/or shift of said Raman bands with respect to the Raman bands of the anhydrous Portland cement. The starting materials were characterized by Raman spectroscopy: CEM 52.5R (C1) and Microsilica; as well as the cementitious composite CC3.1. Additionally, a cementitious composite was characterized following example 1 of the present invention for the sample CC3.1 wherein the percentage of addition of microsilica was modified to obtain 8% by weight and which we shall denominate CC3.0.8. In FIG. 13 it can be seen the different Raman spectra for all the mentioned systems.

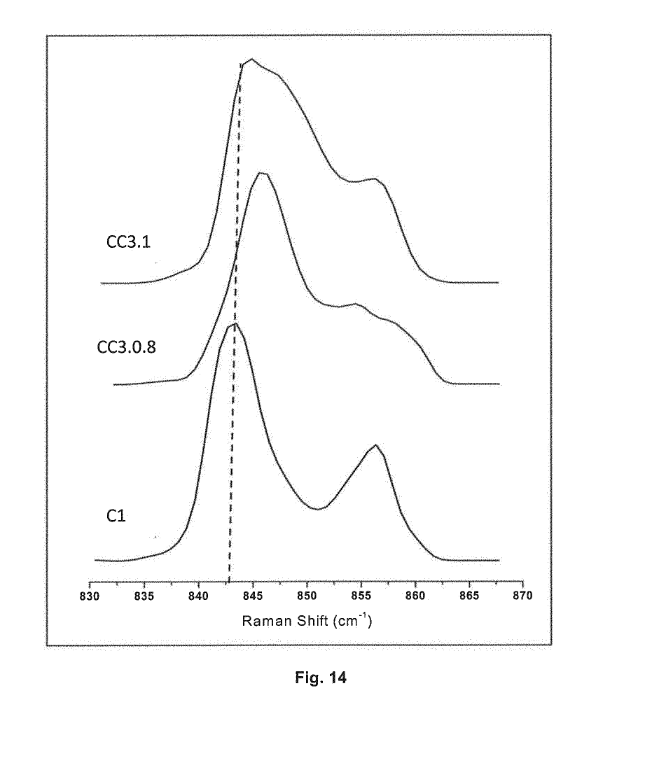

To carry out the study of the effect of the addition of the microsilica on cement C1, anhydrous Portland cement, we proceeded, first, to the characterization of the starting materials separately to identify their major mineralogical phases. In the case of anhydrous Portland cement, there are numerous phases, such as C2S (dicalcium silicate or belite), C3S (tricalcium silicate or alite), C3A (tricalclum aluminate), C4AF (ferritic phase), etc. However, to try to characterize the behavior of the additions of microsilica (whose chemical composition is >85% by weight of SiO₂) to the cement, the Raman modes that appear around 840 cm⁻¹, FIG. 14, are used, which allow to determine the presence of C₂S and C₃S phases of the cement.

The C1 cement has a Raman spectrum where a Raman band located around 840 cm⁻¹, assigned to the presence of the C3S or alite phase, can be appreciated. This Raman band presents a shoulder towards higher values of Raman shift, greater value of cm⁻¹. A second intense and narrow band also appears around 1022 cm⁻¹. Both bands with respective characteristics of the presence of the majority phases of the cement: the tricalcium silicate or alite (C₃S) and the dicalcium silicate or belite (C₂S).

The Raman spectrum of the microsilica shows the existence of very widened Raman bands because the angles of the Si—O—Si bonds are widely distributed throughout the structure. The defect bands D1 and D2 located at 484 and 596 cm⁻¹, respectively, as well as the bands located at 460, 800 and 1 100 cm⁻¹ assigned to the Si—O—SI bonds are clearly visible. The position of the maximum and Raman bands varies within the microsilica, in particular for the characteristic Raman band located at 500 cm⁻¹, being a signal of the differences in crystallization and stress that can be found within the microsilica.

The cementitious composites of the present invention showed a significant modification in the position and intensity of the characteristic Raman bands related to the phases of anhydrous Portland cement. The Raman shift towards the blue of the Raman bands that appears around 840 cm⁻¹ and 857 cm⁻¹, has been found for the cementitious composites of the present invention. The Raman shift towards the blue (higher values of Raman displacement in terms of cm⁻¹) implies that the bond strength constant corresponding to the Raman mode is stronger, that is, the bond is shorter and therefore of higher energy. This Raman shift towards blue means that in the cementitious composites of the present invention the presence of silica particles dispersed on the surface of the same particles modify the crystalline structure of the cement, making its bonds stronger. This effect is evidence of the effective anchoring of the silica particles in the cementitious composite according to the method described in the present invention. In addition, the increase in intensity corresponding to the Raman band at 840 cm⁻¹ with respect to the Raman band at 847 cm⁻¹ evidences a greater presence on the surface of the first phase corresponding to said Raman mode. The aforementioned effects correlate with the modification of the reactivity of the cementitious composites of the present invention and allow modifying the cement microparticles to obtain mortars and long-lasting concrete from the cementitious composites as described in the present invention.

The Raman band corresponding to the microsilica that appeared around 800 cm⁻¹ has an intensity much lower than that expected for the percentage of addition used. This aspect, together with the differences in Raman displacement of the microsilica, makes it impossible to evaluate whether there are modifications in the bonds corresponding to the microsilica. However, the low intensity represents a sign of adequate dispersion since it is not possible to find areas with the exclusive presence of microsilica. This aspect is important to produce a greater degree of reaction during the subsequent hydration process. The adequate dispersion of the particles observed by scanning electron microscopy is confirmed in this way. Therefore, the different additions cause a better homogeneity and distribution of both major phases of the cement (C₂S and C₃S).

In the cementitious composites of the present invention that include silica nanoparticles, these effects have shown to be analogous to those described for microsilica.

In this way, the products of cementitious composites of the present invention are characterized by showing a Raman shift towards the blue of the phases corresponding to the cement with respect to the starting cement. This Raman shift towards higher cm⁻¹ values characterizes the cementitious composite as a material with a structural modification that is produced by the presence of silica particles or silica nanoparticles or by the combination of microsilica and nanosilica. Said silica particles are preferably anchored to the surface of the cement particles. The structural modification of the cement phases is correlated with the modified response of the cementitious composites with respect to conventional cement, since there is a considerable increase in the mechanical resistance at short ages, as well as the values of the electrical resistivity, together with a strong decrease in chlorides migration coefficients compared to mortars and conventional concrete or with mortars and concrete with conventional addition of microsilica and nanosilica. The modification of the cement structure in the cementitious composites of the present invention demonstrates the dispersion of the microsilica or nanosilica particles which thus present an improvement in the appearance of the main cement hydration product (primary C—S—H gel), and gives rise to the appearance of secondary gels due to the pozzolanic activity of the silica. This effect has been found for mortars prepared in the present invention following example 2. By means of Differential Thermal Analysis, the percentage of the gel phase, the percentage of the portlandite phase, which is a hydrated phase of the cement, and the relationship between these phases, were determined for the mortars, Table 13. A significant increase in gel formation was determined for the mortar prepared from the cementitious composite of the present invention.

TABLE 13
BET specific surface of cementitious composites

| | |
|---|---|
| 7 days | 28 days |

| | M1 | M-3.2 | M1 | M-3.2 |
|---|---|---|---|---|
| % gel | 2.602 | 2-963 | 3.181 | 3.381 |
| % free portlandite | 1.157 | 0.968 | 1.263 | 0.981 |
| phase | | | | |
| gel/portlandita | 2.249 | 3.060 | 2.520 | 3.448 |

1. A method for producing a cementitious composite comprising the steps of:
1) a first step of conditioning silica nanoparticles, wherein they are heated to a temperature between 85-235° C., for a sufficiently long time period to achieve a maximum humidity content of 0.3% with regard to the total weight of the material resulting from this first step,
2) a dry dispersion step, in which the nanoparticles conditioned in step 1) are dispersed over cement particles and wherein inert grinding balls are used,
3) a conditioning step of the cementitious composite obtained in step 2), wherein the grinding balls are separated from the cementitious composite obtained.

2. The method according to claim 1, wherein, in the first step, the silica nanoparticles are heated between 100 and 140° C.

3. The method according to claim 1, wherein, in the first step silica nanoparticles are heated following ramps between 1° C. and 100° C./min.

4. The method according to claim 1, wherein, in the first step, a drying equipment is used, selected from:
a drying oven,
an equipment for continuous drying, and
an equipment for drying in infrared oven.

5. The method according to claim 1, wherein, in the first step, silica nanoparticles are obtained with a residual percentage of water of less than 0.2% by weight with regard to the total weight, on cement particles.

6. The method according to claim 1, wherein, in the second dispersion step, the silica nanoparticles and cement are present in a weight ratio between 85 and 99.5% of cement and 15 to 0.5% of silica nanoparticles.

7. The method according to claim 1, wherein, in the second dispersing step, a mixer selected from a kneader, a mixing concrete and biconic mixer is used.

8. The method according to claim 1, wherein f the grinding balls used during the second dispersion step have a size of between 1 mm and 100 mm.

9. The method according to claim 1, wherein, in the second dispersion step, the grinding balls are chosen from microballs of 2 mm diameter, of YTZ, ZrSiO₄ microballs, and steel microballs, and mixtures of the same.

10. The method according to claim 1, wherein, in the second dispersion step, a stirring time between 0.2 and 4 hours is used.

11. The method according to claim 1, wherein among the silica nanoparticles, at least 50% of the silica particles have a size of less than 100 nm.

12. A cementitious composite obtained by the method defined in claim 1, comprising:
cement particles and
silica nanoparticles
in a total proportion of silica nanoparticles from 0.5% to 15% by weight with regard to cement.

13. The cementitious composite according to claim 12, selected from:
a composite with 8% of microsilica and 2% of nanosilica, and
a composite with 10% of microsilica.

14. The cementitious composite according to claim 12, wherein the cement particles are Portland's cement particles.

15. The cementitious composite according to claim 12, wherein among the silica nanoparticles at least 50% of the silica particles have a size of less than 100 nm.

16. A cement-based material prepared with the defined cementitious composite of claim 12 as a cement phase, and which at 28 days of curing comprises ettringite and portlandite crystals of submicron dimensions.

17. The cement-based material according to claim 16, wherein the submicron dimensions of the primary ettringite phase comprise sizes of less than 300 nm, in at least one dimension.

18. The cement-based material according to claim 16, which is selected from one of mortar and concrete.

19. The cement-based material according to claim 18, which is mortar having a resistance to compression at 7 days of at least 77 MPa and a resistance to compression at 28 days of at least 90 MPa, an electrical resistivity at 7 days curing of at least 6.1 kQ·cm and at 28 days of at least 32.2 kQ·cm, and chlorides migration coefficient at 28 days of 2.47 10-12 m²/s.

20. The cement-based material according to claim 18, which is a concrete having a resistance to compression at 7 days of at least 52 MPa and a resistance to compression at 28 days of at least 67 MPa, an electrical resistivity at 7 days of curing of at least 17.17 kQ·cm and at 28 days of at least 81.82 kQ·cm, and chlorides migration coefficient at 28 days of 0.7×10⁻¹²·m²/s.

21. A process for the preparation of cement-based material as defined in claim 16, the process comprising the steps of:
a) obtaining a cementitious composite comprising:
cement particles and
silica nanoparticles in a total proportion of 0.5% to 15% by weight with regard to the cement, preferably 1% to 12% by weight with regard to the cement, and a percentage of residual humidity lower than 1% by weight with regard total weight overall, preferably less than 0.5% by weight with regard to the total weight, and
b) mixing the obtained cementious composite with
at least one aggregate,
water
and additional components required to obtain a cement-based material.

22. The process of claim 21, wherein the cement-based material is concrete and comprises:
a) obtaining a cementitious composite comprising:
cement particles and
silica nanoparticles in a total proportion of 0.5% to 15% by weight with regard to the cement, preferably 1% to 12% by weight with regard to the cement, and a percentage of residual humidity lower than 1% by weight with regard to the total weight, preferably less than 0.5% by weight with regard to the total weight, and
b) mixing the cementitious composite obtained with
at least one aggregate,
water, and
required additional components required to obtain concrete, c) performing operations according to the standard procedure to obtain concrete.

23. The process of claim 21, wherein the cement-based material is a mortar, and comprises:
a) mixing the cementitious composite obtained with
at least one aggregate,
water, and
required additional components to obtain a mortar
b) performing operations according to the standard procedure to obtain a mortar, with the provision of using 90 strokes in the compaction of the samples.

24. The process of claim 21, wherein the cementitious composite is selected from:
a composite with 8% of microsilica and 2% of nanosilica, and
a composite with 10% of microsilica.

25. The process of claim 21, wherein the cement particles are Portland's cement particles.

26. The process of claim 21 wherein mortar or concrete are obtained.

27. The process of claim 21, wherein among the silica nanoparticles at least 50% of the silica particles have a size of less than 100 nm.

28. (canceled)

29. The cement based material according to claim 17 which is selected from one of mortar and concrete.
